(19) United States
(12) Patent Application Publication
(10) Pub. No.: US 2017/0115615 A1
(43) Pub. Date: Apr. 27, 2017

(54) IMAGE FORMING APPARATUS

(71) Applicant: Konica Minolta, Inc., Tokyo (JP)

(72) Inventor: Mikihiro YAMAKAWA, Tokyo (JP)

(21) Appl. No.: 15/293,901

(22) Filed: Oct. 14, 2016

(30) Foreign Application Priority Data
Oct. 23, 2015 (JP) 2015-209168

(51) Int. Cl. G03G 15/00

(52) U.S. Cl. CPC G03G 15/657

(57) ABSTRACT

An image forming apparatus includes: a roller pair configured to convey paper along a conveyance path; a guide member provided in the conveyance path; a detection unit provided in a downstream side of the roller pair in a first direction of a paper conveyance direction and configured to detect a front edge position of the paper; an abutment mechanism provided in a downstream side of the roller pair and in an opposite side of the detection unit with the conveyance path interposed therebetween, the abutment mechanism having an abutment member movable forward/backward with respect to the conveyance path; and a control unit configured to carry out front-edge correction of aligning an image and a paper front edge based on a front edge position of the paper, wherein the control unit controls operation of the abutment member so that a front edge portion of the paper passes through the detection unit.

The entire disclosure of Japanese Patent Application No. 2015-209168 filed on Oct. 23, 2015 including description, claims, drawings, and abstract are incorporated herein by reference in its entirety.

### BACKGROUND OF THE INVENTION

Field of the Invention

The present invention relates to an image forming apparatus.

Description of the Related Art

Conventionally, image forming apparatuses such as a printer or a copy machine employing an electrophotographic method are widely utilized. In a general image forming apparatus, due to factors such as various types and properties of used paper, characteristics of parts such as conveyance rollers, and usage environments such as temperatures and humidity in conveyance, in some cases, the paper is deviated in the direction orthogonal to a conveyance direction (hereinafter, referred to as an axial direction or main scanning direction), or the paper is misaligned in the paper conveyance direction. There has been a problem that, if a printing process is executed in this state, print position accuracy is reduced.

Therefore, in the image forming apparatus, deviation correction of correcting the deviation of the paper by detecting an end position of the paper and paper front-edge correction of detecting front-edge passage timing of the paper and adjusting the speed of a resist roller pair are carried out. For example, JP 2013-20490 A describes an image forming apparatus which aligns paper with an image position by laterally moving a resist roller pair in an axial direction by using a rack, a pinion, etc. JP 2012-206832 A describes an image forming apparatus which detects a front edge of paper by using a turning actuator in accordance with a contact state with the paper passing through a paper conveyance path.

Herein, recently, a sensor with more improved detection accuracy, etc. of paper is used as the sensor which detects the front-edge passage timing of paper in paper front-edge correction. This type of sensor is known to have sensitivity depending on the passage position in the direction perpendicular to the paper (hereinafter, referred to as a height direction). Therefore, if the passage position in the height direction of the conveyance path of the paper is varied, the detection position in the conveyance direction of the paper by the sensor is also varied. Therefore, there has been a problem that paper front edge timing is varied.

FIG. 12 is a view for describing the detection sensitivity of a paper-front-edge detecting sensor 500. FIG. 13 is a graph for describing the relation between detection positions X in a paper conveyance direction D1 and heights Y of the paper-front-edge detecting sensor 500. As shown in FIG. 12, the paper-front-edge detecting sensor 500 is provided in the downstream side of a resist roller pair 510 in the paper conveyance direction D1 and detects a front edge portion of paper P re-conveyed by the resist roller pair 510. This paper-front-edge detecting sensor 500 has a characteristic that detection sensitivity C2 in the height Y direction is widened and misaligned in the direction of a conveyance path R with respect to an optical center C1 as it gets away from a light emitting surface.

Specifically, as shown in FIG. 12 and FIG. 13, for example, if a height Y1 is about 2 mm, a detection position X1 is about −0.95 mm; if a height Y2 is about 2.75 mm, a detection position X2 is about −1.0 mm; and, if a height Y3 is about 3.5 mm, a detection position X3 becomes about −1.09 mm. In this manner, in the conventional paper-front-edge detecting sensor 500, a detection position x is changed around about 0.1 mm depending on the paper passing height of the paper P, and there has been a problem that paper front-edge passage timing is missed.

### SUMMARY OF THE INVENTION

Therefore, in order to solve the above-described problems, it is an object of the present invention to provide an image forming apparatus capable of highly accurately detecting paper front-edge passage timing.

To achieve the abovementioned object, according to an aspect, an image forming apparatus reflecting one aspect of the present invention comprises: a roller pair configured to convey paper along a conveyance path; a guide member provided in the conveyance path; a detection unit provided in a downstream side of the roller pair in a first direction of a paper conveyance direction and configured to detect a front edge position of the paper; an abutment mechanism provided in a downstream side of the roller pair in the first direction and in an opposite side of the detection unit with the conveyance path interposed therebetween, the abutment mechanism having an abutment member movable forward/backward with respect to the conveyance path; and a control unit configured to carry out front-edge correction of aligning an image and a paper front edge based on a front edge position of the paper detected by the detection unit, wherein in the front edge correction, the control unit controls operation of the abutment member so that a front edge portion of the paper passes through the detection unit in a state that the front edge portion of the paper is abutting the guide member.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a view showing a configuration example of an image forming apparatus according to an embodiment of the present invention;

FIG. 2 is a view (No. 1) showing a configuration example of a resist unit;

FIG. 3 is a view (No. 2) showing a configuration example of the resist unit;

FIG. 4 is a view showing a configuration example of an abutment mechanism and a paper-front-edge detecting sensor;

FIG. 5 is a view (No. 1) showing a configuration example of the abutment mechanism;

FIG. 6 is a view (No. 2) showing a configuration example of the abutment mechanism;

FIG. 7 is a view showing a configuration example of a swing mechanism;

FIGS. 8A and 8B are views showing configuration examples and operation examples of a pressure-contact separating mechanism;

FIG. 9 is a block diagram showing a functional configuration example of the image forming apparatus;

FIG. 10 is a flow chart showing a configuration example of the image forming apparatus in image formation;

FIG. 11 is a timing chart showing a configuration example of the image forming apparatus in image formation;

FIG. 12 is a view for describing the detection sensitivity of a paper-front-edge detecting sensor; and

FIG. 13 is a graph showing relation examples of detection heights and detection positions by the paper-front-edge detecting sensor.

### DESCRIPTION OF THE PREFERRED EMBODIMENTS

Hereinafter, preferred embodiments of the present invention will be described in detail with reference to the drawings. However, the scope of the invention is not limited to the illustrated examples. The dimensional proportions of the drawings are expanded for the convenience of description and are different from actual proportions in some cases. Hereinafter, the movement in the direction orthogonal to a paper conveyance direction D1 is referred to as a swing in some cases.

[Configuration Example of Image Forming Apparatus 100]

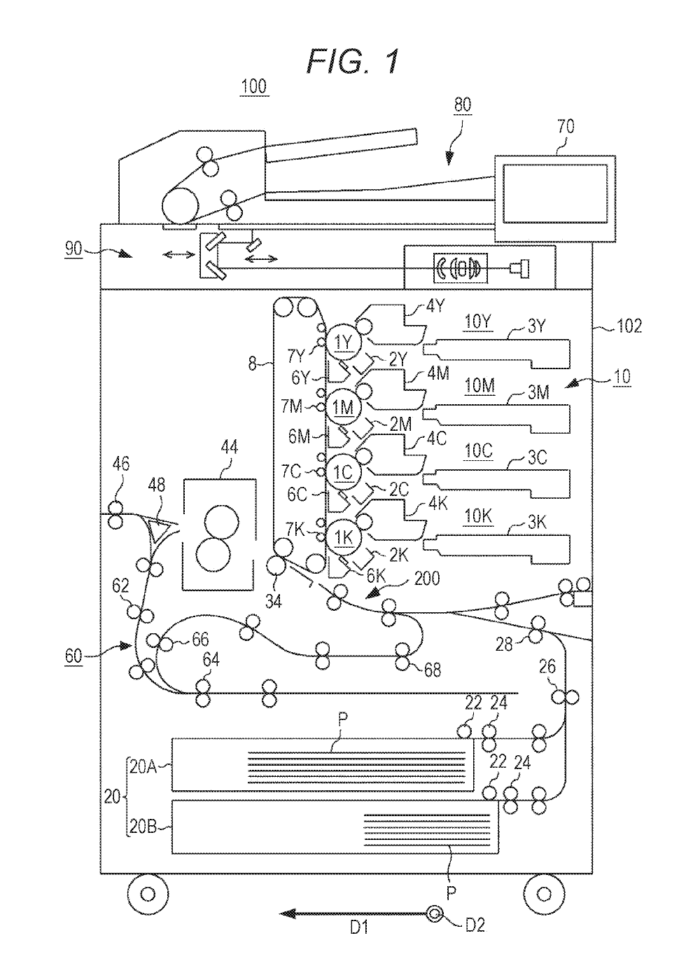

FIG. 1 shows an example of the configuration of an image forming apparatus 100 according to the present invention. As shown in FIG. 1, the image forming apparatus 100 is an apparatus referred to as a tandem-type image forming apparatus and includes an automatic original-copy conveying unit 80 and an apparatus main body 102. The automatic original-copy conveying unit 80 is attached to an upper portion of the apparatus main body 102 and feeds the paper set on a conveyance base to an image reading unit 90 of the apparatus main body 102 by a conveyance roller, etc.

The apparatus main body 102 has: an operation display unit 70, an image reading unit 90, an image forming unit 10, an intermediate transfer belt 8, a paper feeding unit 20, a resist unit 200, a fixation unit 44, and an automatic paper inversion conveyance unit 60 (Auto Duplex Unit: hereinafter, referred to as ADU).

The operation display unit 70 has a touch panel in which a display unit and an input unit are combined and operation keys including a start key and a determination key provided in a peripheral part of the touch panel. The operation display unit 70 displays a menu screen, etc. on a screen and receives image forming conditions such as a paper type input by operations of touch operations or operation keys on the menu screen.

The image reading unit 90 subjects an original copy placed on an original-copy mount or an original copy conveyed by the automatic original-copy conveying unit 80 to scanning exposure by an optical system of a scanning exposure apparatus and subjects the image of the scanned original copy to photoelectric conversion by a CCD (Charge Coupled Device) image sensor to generate image information signals. The image information signals are subjected to analog processing, analog/digital (hereinafter, referred to as A/D) conversion processing, shading correction, image compression processing, etc. by an unshown image processing unit and are then output to the image forming unit 10.

The image forming unit 10 forms images by an electrophotographic method and has an image formation unit 10Y which forms images of an yellow (Y) color, an image formation unit 10M which forms images of a magenta (M) color, an image formation unit 10C which forms images of a cyan (C) color, and an image formation unit 10K which forms images of a black (K) color. In this example, common function names such as a reference sign 10 are described with Y, M, C, and K, which represent the colors formed thereby, thereafter.

The image formation unit 10Y has a photoreceptor drum 1Y, an electrifier 2Y disposed in the periphery thereof, an exposure unit (optical writing unit) 3Y, a developer 4Y, and a cleaning unit 6Y. The image formation unit 10M has a photoreceptor drum 1M, an electrifier 2M disposed in the periphery thereof, an exposure unit 3M, a developer 4M, and a cleaning unit 6M. The image formation unit 10C has a photoreceptor drum 1C, an electrifier 2C disposed in the periphery thereof, an exposure unit 3C, a developer 4C, and a cleaning unit 6C. The image formation unit 10K has a photoreceptor drum 1K, an electrifier 2K disposed in the periphery thereof, an exposure unit 3K, a developer 4K, and a cleaning unit 6K.

The photoreceptor drums 1Y, 1M, 1C, and 1K, the electrifiers 2Y, 2M, 2C, and 2K, the exposure units 3Y, 3M, 3C, and 3K, the developers 4Y, 4M, 4C, and 4K, and the cleaning units 6Y, 6M, 6C, and 6K in the image formation units 10Y, 10M, 10C, and 10K have mutually common configurations. Hereinafter, except for the case which particularly requires distinguishing, these will be described without Y, M, C, and K.

The electrifier 2 electrifies a surface of the photoreceptor drum 1 approximately uniformly. The exposure unit 3 includes, for example, an LPH (LED Print Head) having an LED array and an imaging lens or a laser exposure scanning apparatus of a polygon mirror method, and the exposure unit 3 carries out scanning on the photoreceptor drum 1 by laser light and forms an electrostatic latent image based on the image information signal. The developer 4 develops the electrostatic latent image, which is formed on the photoreceptor drum 1, by toner. As a result, a toner image which is a visible image is formed on the photoreceptor drum 1.

The intermediate transfer belt 8 is stretched and rotatably supported by a plurality of rollers. A primary transfer roller 7 and the photoreceptor drum 1 are rotated along with turning of the intermediate transfer belt 8, and a predetermined voltage is applied between the primary transfer roller 7 and the photoreceptor drum 1. As a result, the toner image formed on the photoreceptor drum 1 is transferred onto the intermediate transfer belt 8 (primary transfer).

The paper feeding unit 20 has a plurality of paper feeding trays 20A and 20B in which paper P of, for example, A3 and A4 are housed. The paper P conveyed from the paper feeding trays 20A and 20B by conveyance rollers 22, 24, 26, 28, etc. is conveyed to the resist unit 200. The number of the paper feeding trays is not limited to two. In accordance with needs, a single or plural large-volume paper feeding apparatus(es) capable of housing a large volume of paper P may be coupled thereto.

The resist unit 200 carries out paper-front-edge alignment correction, etc. to correct bending of paper by abutting paper front edges. The paper P, which has undergone correction of bending, deviation, etc. of the paper P, is conveyed to a secondary transfer unit 34 at predetermined timing. In the secondary transfer unit 34, the toner images of the color Y, the color M, the color C, and the color K transferred onto the intermediate transfer belt 8 are collectively transferred to a surface of the paper P conveyed from a resist roller pair 32 (secondary transfer). The paper P, which has undergone the secondary transfer, is conveyed to the fixation unit 44 in a downstream side in the paper conveyance direction D1.

The fixation unit 44 has a pressurizing roller and a heating roller. The fixation unit 44 subjects the paper P, to which the toner images have been transferred by the secondary transfer unit 34, to pressurizing and heating processing, thereby fixing the toner images on the surface of the paper P onto the paper P.

A conveyance-path switching unit 48 is provided in a downstream side of the fixation unit 44 in the paper conveyance direction D1 and carries out control to switch the conveyance path of the paper P to a paper-discharging path side or to the ADU 60 side based on a selected print mode (one-side print mode, both-side print mode, etc.). The paper P for which one-side printing in the one-side print mode has been finished or the paper P for which both-side printing in the both-side printing mode has been finished is discharged onto an unshown paper-discharging tray by a paper-discharging roller 46.

If an image is to be formed on a back surface side of the paper P in the both-side print mode, the paper P on which an image has been formed on a front surface side is conveyed to the ADU 60 via a conveyance roller 62, etc. In a switchback path of the ADU 60, the paper P is conveyed to a U-turn path unit while a rear edge thereof is placed at a top by backward rotation control of the ADU roller 64, and the paper P is fed again to the secondary transfer unit in a state in which the paper P is in a front/back inverted state by conveyance rollers 66, 68, etc. provided in the U-turn path unit.

[Configuration Example of Resist Unit 200]

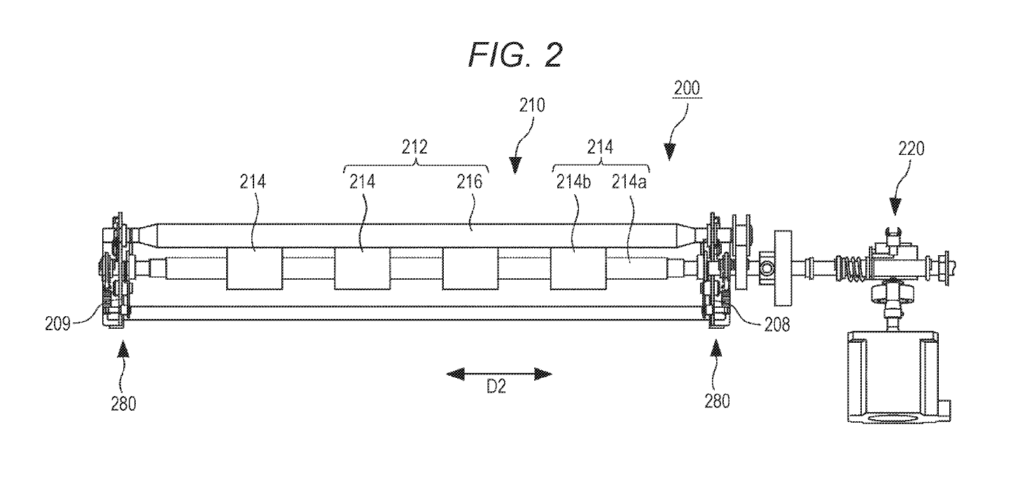

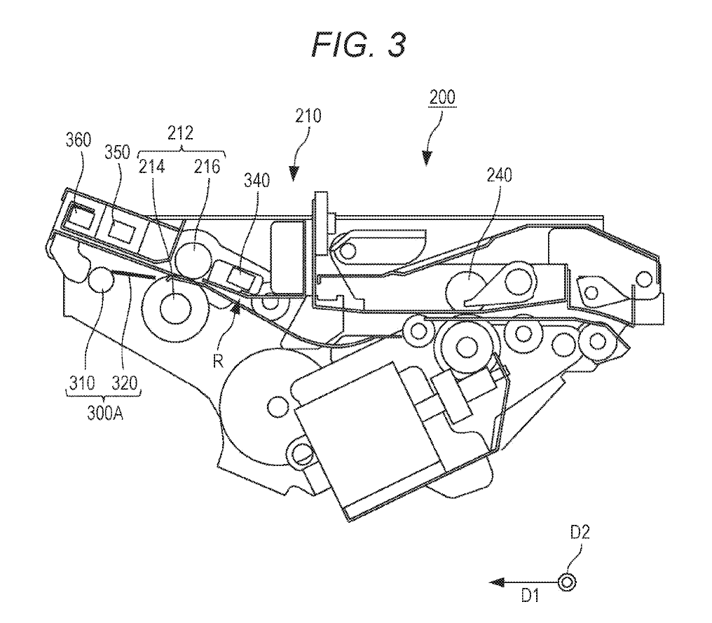

FIG. 2 shows an example of a configuration of the resist unit 200 in a case in which it is viewed from the paper conveyance direction D1. FIG. 3 shows an example of a cross-sectional configuration of the resist unit 200.

As shown in FIG. 2 and FIG. 3, the resist unit 200 includes a conveyance mechanism 210, a resist sensor 340, a deviation detecting sensor 350, a paper-front-edge detecting sensor 360, a swing mechanism (movement mechanism) 220, pressure-contact separating mechanisms 280, and an abutment mechanism 300A.

The conveyance mechanism 210 has a resist roller pair 212 and a loop roller pair 240. The resist roller pair 212 carries out bending correction of the paper P by abutment of the paper front edge, front-edge correction of aligning the paper front edge with an image front edge after paper re-conveyance, and deviation correction of correcting deviation of the paper P in an axial direction D2. The resist roller pair 212 has a resist roller (drive roller) 214, which is subjected to rotary drive, and a driven roller 216, which is driven along with the rotation of the resist roller 214.

The resist roller 214 includes, for example, a shaft 214a formed of SUS or the like and a plurality of rubber rollers 214b, which are divided from one another with predetermined intervals and attached to the shaft 214a. Both ends of the shaft 214a of the resist roller 214 are rotatably and slidably supported by bearing parts provided in panels 208 and 209, respectively.

The driven roller 216 is disposed to be opposed to the resist roller 214 and is formed of a material such as SUS. The driven roller 216 is rotatably and slidably supported by bearing parts of the panels 208 and 209 and is configured to be able to be brought into pressure-contact with or separated from the resist roller 214 by the pressure-contact separating mechanisms 280.

The loop roller pair 240 is a member for adjusting the feed amount of the paper P when a loop is to be created. The loop roller pair 240 has a pair of conveyance rollers and is disposed in an upstream side of the resist roller 214 in the paper conveyance direction D1. As well as the resist roller 214, the loop roller pair 240 is formed of a material such as SUS or rubber and is configured to be able to be brought into pressure-contact or separation.

The resist sensor 340 includes, for example, a reflection-type or transmission-type optical sensor and is disposed in a conveyance path R between the loop roller pair 240 and the resist roller pair 212. The resist sensor 340 is a sensor for calculating the conveyance distance (feed amount), etc. of the paper P in a case of loop creation and detects the conveyed paper P.

The deviation detecting sensor 350 includes, for example, a line sensor and is disposed in the downstream side of the resist roller pair 212 in the paper conveyance direction D1. The deviation detecting sensor 350 is a sensor for acquiring the deviation amount of the paper P and detects an end position of the conveyed paper P in the axial direction D2.

The paper-front-edge detecting sensor 360 includes, for example, a reflection-type optical sensor and is disposed in the downstream side of the deviation detecting sensor 350 in the paper conveyance direction D1 and in an image-printed-surface side to which an image is transferred by the secondary transfer unit 34. The paper-front-edge detecting sensor 360 is a sensor for acquiring the misaligned amount between the paper front edge and the transferred image and detects a front edge position of the conveyed paper P. In the present example, for example, as the paper-front-edge detecting sensor 360, a sensor which has a short sampling cycle and is capable of detecting the front edge position of the paper P by one time of measurement is used.

[Configuration Example of Abutment Mechanism 300A]

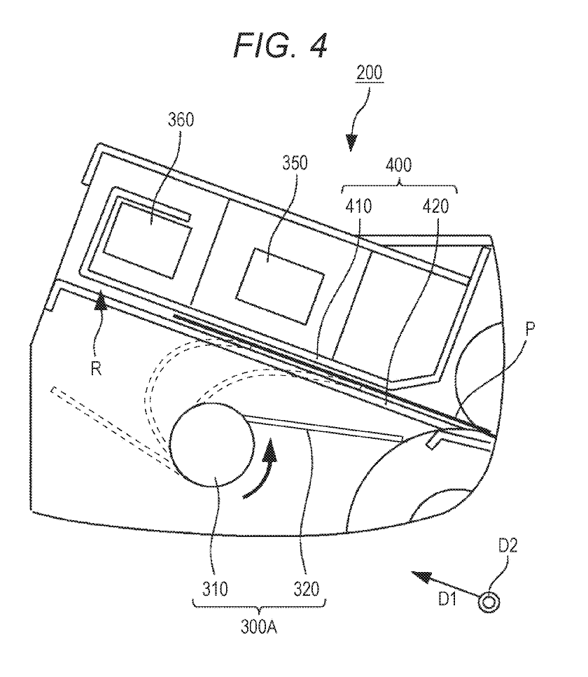

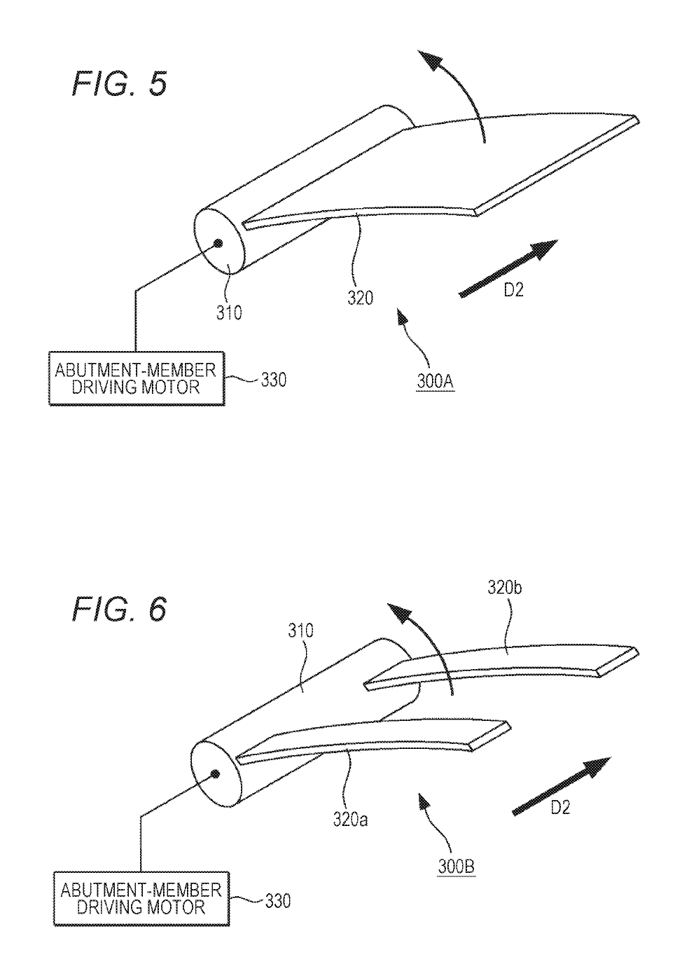

FIG. 4 is a cross-sectional view showing an example of the configuration of the resist unit 200 including the abutment mechanism 300A. FIG. 5 is a perspective view showing an example of the configuration of the abutment mechanism 300A.

As shown in FIG. 4 and FIG. 5, the abutment mechanism 300A is a member for conveying the paper P while pressing a front edge portion of the paper P against an inner surface side of a guide plate 410 in a case of paper front-edge correction, and the abutment mechanism 300A is disposed in the opposite side of the paper-front-edge detecting sensor 360 with the conveyance path R (paper P) interposed therebetween. In other words, the abutment mechanism 300A is disposed in a lower side of the guide plate 420 and in a peripheral part of the paper-front-edge detecting sensor 360.

The abutment mechanism 300A includes a shaft member 310, an abutment member (paddle) 320, and an abutment-member driving motor 330. The shaft member 310 has a predetermined length and is disposed so that the longitudinal direction thereof is along the axial direction D2. The shaft member 310 is connected to the abutment-member driving motor 330, which will be described later, via an unshown gear, etc. and is rotated in the direction of an arrow based on drive of the abutment-member driving motor 330.

The abutment member 320 includes a bendable flexible member having a flat shape, and a first end thereof is attached to a peripheral surface of the shaft member 310. The length of the abutment member 320 in the axial direction D2 is, for example, is selected to be equal to or shorter than the length of the used paper P in the axial direction D2. The abutment member 320 is rotated along with the rotation of the shaft member 310; and, as a result, the abutment member 320 is moved into (enters) the conveyance path R and is moved to an abutment position at which the front edge portion of the paper P abuts the inner surface of the guide plate 410, or the abutment member 320 escapes to the outside of the conveyance path R and is moved to an escape position at which the front edge portion of the paper P is separated from the inner surface of the guide plate 410. In FIG. 4, the state of the abutment member 320 in a case of rotation is shown by broken lines.

[Configuration Example of Abutment Mechanism 300B]

In the example shown in FIG. 5, the abutment member 320 is formed by a single body, but is not limited thereto, and the abutment member 320 may be formed by a plurality of members. FIG. 6 shows an example of the configuration of another abutment mechanism 300B. As shown in FIG. 6, the abutment mechanism 300B includes the shaft member 310 and two abutment members 320a and 320b. The description about the configuration common to the abutment mechanism 300A will be omitted.

The abutment members 320a and 320b include bendable flexible members having belt shapes, and first ends thereof are attached to the peripheral surface of the shaft member 310. Specifically, the abutment members 320a and 320b are attached to the shaft member 310 with a predetermined interval therebetween so that they are positioned respectively in both end sides of the paper-front-edge detecting sensor 360 in the axial direction D2. The abutment members 320a and 320b are rotated along with the rotation of the shaft member 310, and the abutment members 320a and 320b are moved into the conveyance path R and are moved to abutment positions at which the front edge portion of the paper P abuts the inner surface of the guide plate 410; or the abutment members 320a and 320b escape to the outside of the conveyance path R and are moved to escape positions at which the front edge portion of the paper P is separated from the inner surface of the guide plate 410. Since the abutment members 320a and 320b are disposed in both sides of the paper-front-edge detecting sensor 360, the paper P can be more reliably brought into abutment by the guide plate 410.

In the above-described example, the example in which the two abutment members 320a and 320b are attached in the axial direction D2 of the shaft member 310 has been described. However, the present invention is not limited thereto, and three or more abutment members 320 may be attached. Alternatively, a plurality of abutment members 320 may be attached with a predetermined interval therebetween in a circumferential direction of the shaft member 310 instead of the axial direction D2 of the shaft member 310. Furthermore, the abutment member may be formed by combining them. In the guide plate 420, an unshown opening(s) is formed at the position(s) corresponding to a passage region (s) of turning of the abutment member (s) 320 or 320a and 320b, so that the turned abutment member(s) 320 or 320a and 320b does not contact the guide plate 420.

[Configuration Example and Operation Example of Swing Mechanism 220]

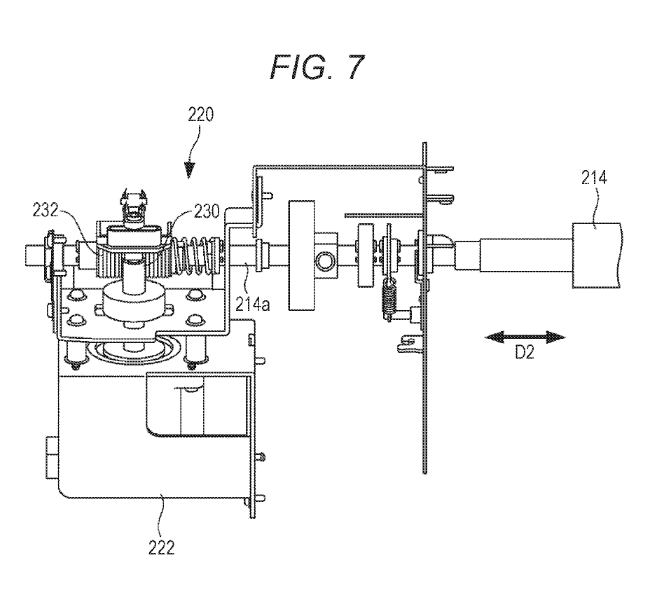

FIG. 7 shows an example of the configuration of the swing mechanism 220. As shown in FIG. 7, the swing mechanism 220 is a mechanism for swinging (moving) the paper P in the axial direction D2 and has a resist-roller swing motor 222, a pinion gear 230, and a rack 232.

The resist-roller swing motor 222 includes, for example, a stepping motor or the like and carries out rotary drive based on drive control of a later-described control unit 50. The pinion gear 230 is connected to a rotary shaft of the resist-roller swing motor 222 and is rotated along with drive of the resist-roller swing motor 222. The rack 232 is meshed with the pinion gear 230 and is attached to the shaft 214a of the resist roller 214. The shaft 214a of the resist roller 214 is rotatable with respect to the rack 232. The rack 232 is biased toward the inner side (resist roller 214 side) by an unshown spring.

In the swing mechanism. 220, when the resist-roller swing motor 222 is driven along with execution of deviation correction, the pinion gear 230 is rotated, and, as a result, the rack 232 swings in the axial direction D2. In other words, the rotative force of the pinion gear 230 is converted to linear motion by the rack 232. Along with movement of the rack 232 in the axial direction D2, the resist roller 214 (resist roller pair 212) also swings along the axial direction D2.

[Configuration Example and Operation Examples of Pressure-Contact Separating Mechanisms 280]

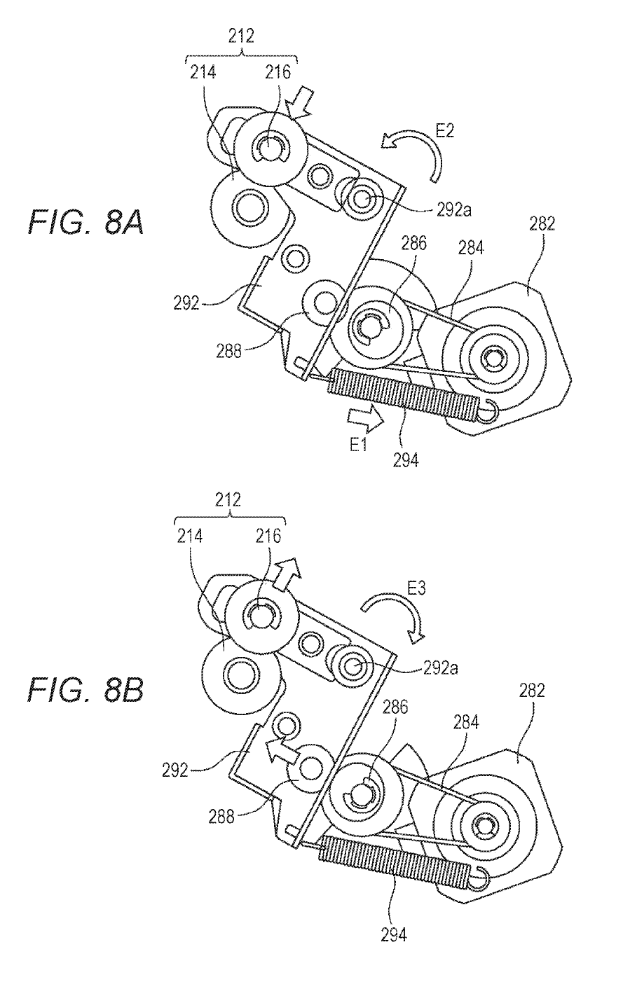

FIGS. 8A and 8B are views showing configuration examples and operation examples of the pressure-contact separating mechanism. 280. FIGS. 8A and 8B have different cross-sectional positions from that of the resist unit 200 shown in FIG. 3.

The pressure-contact separating mechanisms 280 are mechanisms for releasing the pressure-contact of the resist roller pair 212 and are disposed respectively in both end sides of the driven roller 216 (see FIG. 2). These pressure-contact separating mechanisms 280, 280 are coupled via a cam shaft 296 (see FIG. 2) so as to be operated in cooperation with each other. Since the pressure-contact separating mechanisms 280, 280 have similar configurations, hereinafter, only the configuration of the pressure-contact separating mechanism. 280 of one side will be described.

The pressure-contact separating mechanism 280 has a driven-roller retaining member 292, a resist pressure-contact/release motor 282, a pressure-contact separating cam 286, a pressure-contact-separating-cam follower 288, and a resist-roller pressing spring 294. The driven-roller retaining member 292 is a flat plate member forming an approximately triangular shape in a planar view, and a first end of the driven roller 216 is rotatably attached to a corner portion thereof in the left side in the drawing. The driven-roller retaining member 292 turns in accordance with the rotation angle of the pressure-contact separating cam 286 and brings the driven roller 216 into pressure-contact with the resist roller 214 or separate the driven roller 216 from the resist roller 214.

The pressure-contact separating cam 286 is a disc cam, is connected to the resist pressure-contact/release motor 282 via belt 284, etc., and is rotated at a predetermined rotation angle by drive of the resist pressure-contact/release motor 282. The pressure-contact-separating-cam follower 288 is attached to the driven-roller retaining member 292 by the position opposed to the pressure-contact separating cam 286. When the pressure-contact separating cam 286 is at the predetermined rotation angle, the pressure-contact separating cam 286 abuts (presses) the pressure-contact-separating-cam follower 288 and turns the driven-roller retaining member 292 while using a rotary shaft 292a as a pivot point in the direction in which the driven roller 216 is separated from the resist roller 214.

The resist-roller pressing spring 294 includes, for example, a tension spring, a first end thereof is attached to a lower end surface of the driven-roller retaining member 292 in the side of the resist pressure-contact/release motor 282, and a second end thereof is attached to an unshown main-body panel. As a result, when the driven-roller retaining member 292 is pulled toward the resist pressure-contact/release motor 282 side, the driven roller 216 is biased toward the resist roller 214 side.

Next, the operation examples of the pressure-contact separating mechanism 280 will be described. As shown in FIG. 8A, if the position at which the diameter of the pressure-contact separating cam 286 is small (the distance from the center to the outer peripheral surface thereof is short) is opposed to the pressure-contact-separating-cam follower 288, the pressure-contact separating cam 286 and the pressure-contact-separating-cam follower 288 are in a mutually separated state, and the force of the pressure-contact separating cam 286 does not work. Therefore, the driven-roller retaining member 292 is pulled in an arrow direction E1 by the resist-roller pressing spring 294 and is, for example, turned in a counterclockwise direction (arrow direction E2 in the view) while using the rotary shaft 292a as a pivot point. As a result, the driven roller 216 is brought into pressure-contact with the resist roller 214 with a predetermined nip load.

On the other hand, as shown in FIG. 8B, if the position at which the diameter of the pressure-contact separating cam 286 is large (the distance from the center to the outer peripheral surface thereof is long) is opposed to the pressure-contact-separating-cam follower 288, the pressure-contact separating cam 286 abuts the pressure-contact-separating-cam follower 288, thereby pushing up the pressure-contact-separating-cam follower 288. Therefore, the driven-roller retaining member 292 is turned in a clockwise direction (arrow direction E3 in the view) by the pressing force of the pressure-contact separating cam 286 while using the rotary shaft 292a as a pivot point. As a result, the driven roller 216 is separated from the resist roller 214.

[Block Configuration Example of Image Forming Apparatus 100]

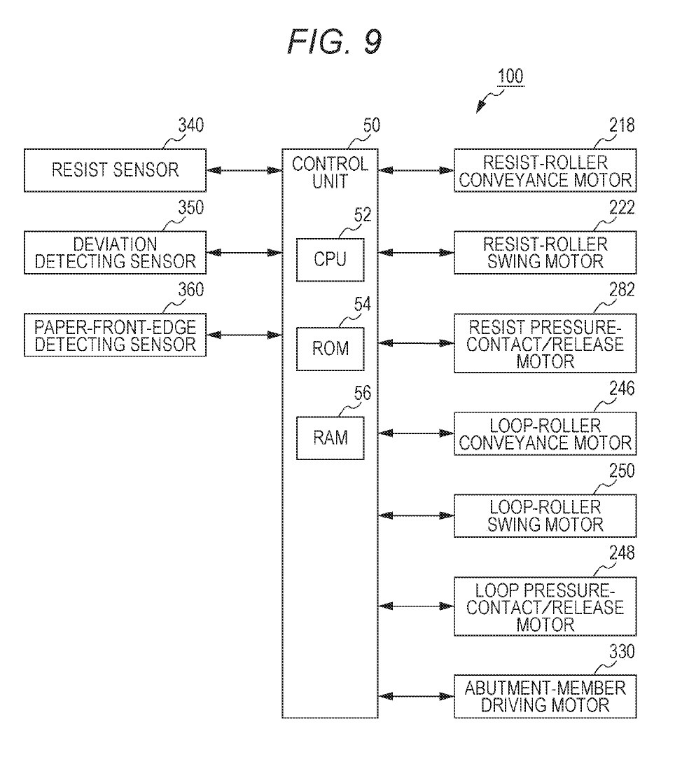

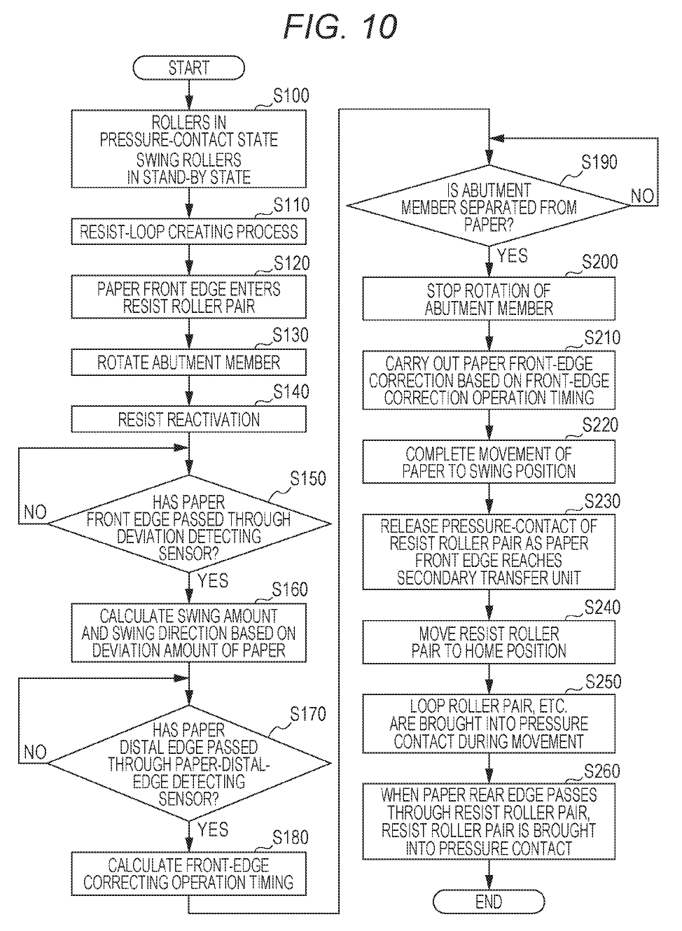

FIG. 9 is a block diagram showing an example of the functional configuration of the image forming apparatus 100. As shown in FIG. 9, the image forming apparatus 100 includes the control unit 50 for controlling operations of the entire apparatus. The control unit 50 has a CPU (Central Processing Unit) 52, ROM (Read Only Memory) 54, and RAM (Random Access Memory) 56. The CPU 52 executes software (program) read from the ROM 54, thereby controlling the units of the image forming apparatus 100 and realizing the functions related to image formation including rotation control of the abutment member 320.

The resist sensor 340, the deviation detecting sensor 350, the paper-front-edge detecting sensor 360, a resist-roller conveyance motor 218, the resist-roller swing motor 222, the resist pressure-contact/release motor 282, a loop-roller conveyance motor 246, a loop-roller swing motor 250, a loop pressure-contact/release motor 248, and the abutment-member driving motor 330 are connected to the control unit 50.

The resist-roller conveyance motor 218 is driven based on drive signals, which are supplied from the control unit 50, and subjects the resist roller pair 212 to rotary drive, thereby conveying the paper P along the paper conveyance direction D1. The resist-roller swing motor 222 is driven based on drive signals, which are supplied from the control unit 50, and moves the resist roller pair 212 in the axial direction D2. The resist pressure-contact/release motor 282 is driven based on drive signals, which are supplied from the control unit 50, and brings the resist roller pair 212 to pressure-contact or separate them from each other.

The loop-roller conveyance motor 246 is driven based on drive signals, which are supplied from the control unit 50, and subjects the loop roller pair 240 to rotary drive, thereby conveying the paper P along the paper conveyance direction D1. The loop-roller swing motor 250 is driven based on drive signals, which are supplied from the control unit 50, and moves the loop roller pair 240 in the axial direction D2. The loop pressure-contact/release motor 248 is driven based on drive signals, which are supplied from the control unit 50, and brings the loop roller pair 240 to pressure-contact or separate them from each other.

The abutment-member driving motor 330 includes, for example, a stepping motor or the like, is driven based on drive signals, which are supplied from the control unit 50, and rotates the abutment member 320 via the shaft member 310.

[Operation Example of Image Forming Apparatus 100]

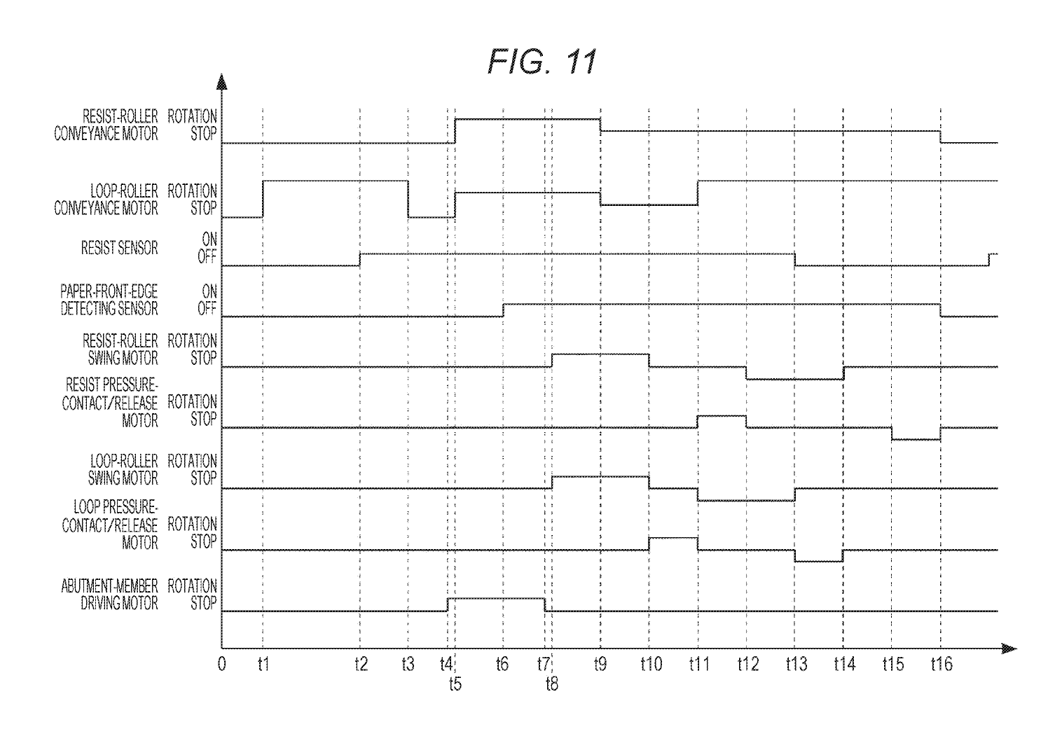

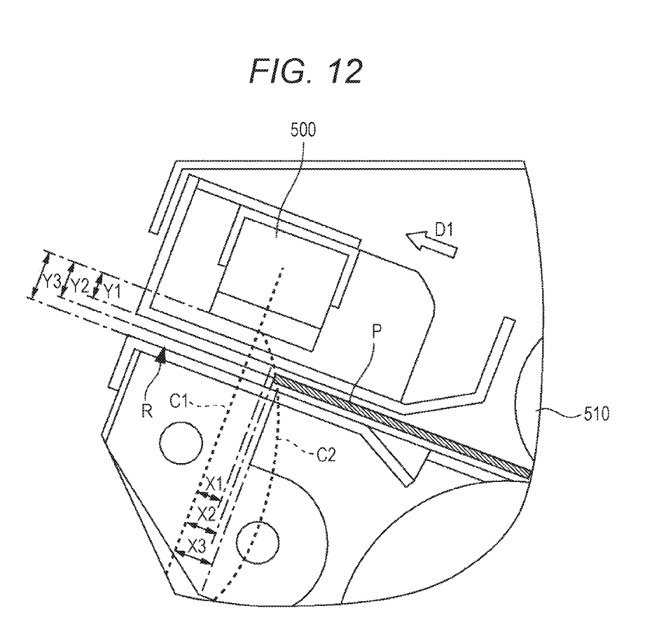

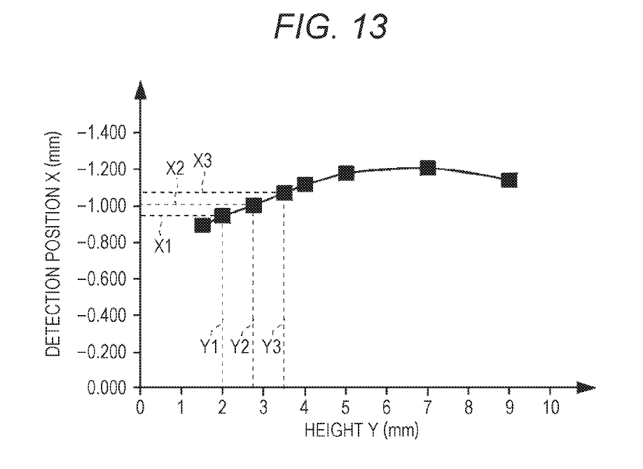

FIG. 10 is a flow chart showing an example of operations of the image forming apparatus 100 in a case of carrying out an image forming process. The control unit 50 of the image forming apparatus 100 executes the program read from a memory such as the ROM 54, thereby executing an operation sequence shown in the flow chart of FIG. 10. Hereinafter, the case in which the abutment mechanism 300A shown in FIG. 5 is used will be described.

In step S100, as a job is started, the control unit 50 brings the resist roller pair 212, the loop roller pair 240, and conveyance roller pairs in the upstream side of these roller pairs in the paper conveyance direction D1 into a pressure-contact state. The control unit 50 brings the swing mechanism 220 which swings the resist roller pair 212, a swing mechanism which swings the loop roller pair 240, etc. into a stand-by state. When step S100 is finished, the process proceeds to step S110.

In step S110, the control unit 50 starts a resist-loop creating process. For example, the control unit 50 drives the loop roller pair 240 by forward rotation and drives or stops the resist roller pair 212 by backward rotation. When step S110 is finished, the process proceeds to step S120.

In step S120, as the resist-loop creating process is started, the front edge portion of the paper P enters the nip between the resist roller pair 212. As a result, a loop is created at the paper P, and bending of the paper P is corrected. When step S120 is finished, the process proceeds to step S130.

In step S130, as paper re-conveyance is started, the control unit 50 rotates the abutment member 320 in the arrow direction of FIG. 4. As a result, the front edge portion of the paper P for which conveyance is to be started thereafter is pushed up from the lower side by the abutment member 320, and the paper P is conveyed in a state in which the front edge portion of the paper P is abutting the inner surface side of the guide plate 410. The control unit 50 carries out control so that the speed of the period in which the rotating abutment member 320 is contacting the paper P being conveyed becomes equivalent to the paper conveyance speed or equal to or higher than the paper conveyance speed. In other words, the speed of the period from contact of the abutment member 320 to the paper P to separation of the abutment member 320 from the paper P is set to be equivalent to the paper conveyance speed or equal to or higher than the paper conveyance speed. When step S130 is finished, the process proceeds to step S140.

In step S140, the control unit 50 reactivates the resist roller pair 212 and the loop roller pair 240, thereby restarting conveyance of the paper P (resist reactivation). The control unit 50 releases the pressure-contact of the rollers of the loop roller pair 240, etc. and brings them into a separated state. When step S140 is finished, the process proceeds to step S150.

In step S150, the control unit 50 judges whether the front edge portion of the paper P has passed through the deviation detecting sensor 350 or not. In other words, whether the front edge portion of the paper P has been detected by the deviation detecting sensor 350 or not is judged. If the control unit 50 judges that the front edge portion of the paper P has passed through the deviation detecting sensor 350, the process proceeds to step S160. On the other hand, if the control unit 50 judges that the front edge of the paper P has not passed through the deviation detecting sensor 350, whether the paper P has passed therethrough or not is continuously checked.

In step S160, the control unit 50 acquires end-position information of the paper P detected by the deviation detecting sensor 350 and calculates a deviation amount of the paper P, which is being conveyed. Based on the acquired end-position information of the paper P, the control unit 50 calculates swing command values. The swing command values include a swing amount of the paper P and a swing direction indicating an apparatus back side or an apparatus front side. When step S160 is finished, the process proceeds to step S170.

In step S170, the control unit 50 judges whether the front edge portion of the paper P has passed through the paper-front-edge detecting sensor 360 or not. In other words, whether the front edge portion of the paper P has been detected by the paper-front-edge detecting sensor 360 or not is judged. If the control unit 50 judges that the front edge portion of the paper P has passed through the paper-front-edge detecting sensor 360, the process proceeds to step S180. On the other hand, if the control unit 50 judges that the front edge portion of the paper P has not passed through the paper-front-edge detecting sensor 360, whether the paper P has passed therethrough or not is continuously checked.

In step S180, based on the front-edge passage timing of the paper P detected by the paper-front-edge detecting sensor 360, the control unit 50 calculates front-edge correction operation timing (correction value) for aligning the front edge of the paper P and the image front edge. Based on the calculated front-edge correction operation timing, the control unit 50 carries out position adjustment correction of the front edge of the paper P and the image front edge. When step S180 is finished, the process proceeds to step S190.

In step S190, the control unit 50 judges whether the abutment member 320 is separated from the paper P or not. For example, the control unit 50 sets, in advance as a timer, a pulse number (time) of the movement from an initial position of the abutment member 320 to an escape position at which the abutment member 320 is separated from the paper P; and, when the set timer is finished, the control unit 50 judges that the abutment member 320 is separated from the paper P. If the control unit 50 judges that the abutment member 320 has not been separated from the paper P, the timing at which the abutment member 320 is separated from the paper P is continuously judged.

On the other hand, if the control unit 50 judges that the abutment member 320 has been separated from the paper P, the process proceeds to step S200. In step S200, the control unit 50 stops the rotation of the abutment member 320. As a result, after the paper P has passed through the paper-front-edge detecting sensor 360, the abutment member 320 stops at the escape position at which the abutment member 320 is separated from the paper P. When step S200 is finished, the process proceeds to step S210.

In step S210, based on the calculated front-edge-position-correction operation timing, the control unit 50 controls drive of the resist-roller conveyance motor 218, thereby starting paper front-edge correction. When step S210 is finished, the process proceeds to step S220. The paper front-edge correction is only required to be carried out before the paper P reaches the secondary transfer unit 34.

In step S220, based on the calculated swing amount and swing direction, the control unit 50 carries out deviation correction of swinging the resist roller pair 212 in the axial direction D2 while the paper P is conveyed in the paper conveyance direction D1 in the state in which the paper P is sandwiched by the resist roller pair 212. If the swing of the paper P to the axial direction D2 is completed, the movement of the resist roller pair 212 to the axial direction D2 is stopped. As a result, deviation of the paper P is corrected. The paper P is conveyed toward the secondary transfer unit 34. When step S220 is finished, the process proceeds to step S230.

In step S230, when the front edge portion of the paper P, which is being conveyed, reaches the secondary transfer unit 34, the control unit 50 releases the pressure-contact of the resist roller pair 212 since the paper P is conveyed only in the secondary transfer unit 34. When step S230 is finished, the process proceeds to step S240.

In step S240, the control unit 50 swings (returns) the resist roller pair 212 to a home position. When step S240 is finished, the process proceeds to step S250.

In step S250, while the resist roller pair 212 is being moved to the home position, the control unit 50 brings the loop roller pair 240 and the conveyance rollers in the upstream side thereof into a pressure-contact state. When step S250 is finished, the process proceeds to step S260.

In step S260, when the movement of the resist roller pair 212 to the home position is completed and when a rear edge portion of the paper P passes through the resist roller pair 212, the control unit 50 brings the resist roller pair 212 into a pressure-contact state. As a result, preparation for carrying out deviation correction, etc. of next paper is made. In the present example, the series of processes as described above is repeatedly executed for each paper.

[Timing Chart of Image Forming Apparatus 100 in Image Formation]

FIG. 11 shows an example of a timing chart of the image forming apparatus 100 in image formation.

As shown in FIG. 11, at time t1, the control unit 50 turns on the loop-roller conveyance motor 246 and rotates the loop roller pair 240, thereby conveying the paper P toward the resist roller pair 212.

When the paper P is conveyed by the loop roller pair 240, at time t2, the front edge portion of the paper P is detected by the resist sensor 340. Based on the detection result of the resist sensor 340, the control unit 50 calculates stop timing of the loop roller pair 240. When the paper P is conveyed by the loop roller pair 240, the front edge portion of the paper P abuts the resist roller pair 212 and is warped, thereby forming a predetermined amount of loop for the paper P (resist-loop creating process). Bending of the paper P is corrected by this resist-loop creating process.

At time t3, the control unit 50 turns off the loop-roller conveyance motor 246 to stop the rotation of the loop roller pair 240.

At time t4, the control unit 50 turns on the abutment-member driving motor 330 to rotate the abutment member 320. In other words, before the front edge portion of the paper P is detected by the paper-front-edge detecting sensor 360, the rotation of the abutment member 320 is started in advance. As a result, the front edge portion of the paper P for which conveyance is to be started thereafter is pushed up from the lower side by the abutment member 320 and abuts the inner surface of the guide plate 410.

At time t5, the control unit 50 turns on the resist-roller conveyance motor 218 to rotate the resist roller pair 212 and turns on the loop-roller conveyance motor 246 to rotate the loop roller pair 240, thereby starting re-conveyance of the paper P (resist re-conveyance process).

When re-conveyance of the paper P is started, at time t6, the front edge portion of the paper P is detected by the paper-front-edge detecting sensor 360. At this point, since the paper P is abutting the guide plate 410, the passage position of the paper P in a height direction becomes constant. Based on the detection result of the paper-front-edge detecting sensor 360, the control unit 50 calculates the paper front-edge correction operation timing (correction values) for aligning the front edge of the paper P and the image front edge transferred to the intermediate transfer belt 8.

At time t7, when certain time elapses after the front edge portion of the paper P is detected by the paper-front-edge detecting sensor 360, the control unit 50 stops the drive of the abutment-member driving motor 330. In other words, when the front edge portion of the paper P is separated from the inner surface side of the guide plate 410, the rotation of the abutment member 320 is stopped.

At time t8, the control unit 50 turns on the resist-roller swing motor 222 and the loop-roller swing motor 250, thereby swinging the resist roller pair 212 and the loop roller pair 240 in the axial direction D2. As a result, the resist roller pair 212 and the loop roller pair 240 swing in the axial direction D2 in the state in which the paper P is sandwiched by the resist roller pair 212 and the loop roller pair 240, and deviation of the paper P is corrected.

At time t9, based on the calculated paper front-edge correction operation timing, the control unit 50 subjects the resist-roller conveyance motor 218 to deceleration control, thereby decelerating the rotation of the resist roller pair 212 and subjects the loop-roller conveyance motor 246 to deceleration control, thereby decelerating the rotation of the loop roller pair 240. As a result, the position adjustment correction of the front edge of the paper P and the image front edge of the intermediate transfer belt 8 is carried out (front-edge correction).

At time t10, when the swing based on the swing command values is completed, the control unit 50 turns off the resist-roller swing motor 222 and the loop-roller swing motor 250, thereby stopping the swinging of the resist roller pair 212 and the loop roller pair 240 in the axial direction D2. Moreover, at the time t10, the control unit 50 turns on the loop pressure-contact/release motor 248 to subject the loop roller pair 240 to nipping release and separation before the resist roller pair 212.

At time t11, the control unit 50 accelerates the loop-roller conveyance motor 246 to return to a paper feeding line speed in order to receive next paper. Moreover, when the paper P reaches a nip part of the secondary transfer unit 34, the control unit 50 turns on the resist pressure-contact/release motor 282 to release the pressure-contact of the resist roller pair 212 and separate them from each other. Moreover, the control unit 50 subjects the loop-roller swing motor 250 to backward drive (backward rotation), thereby moving the loop roller pair 240 to the home position in the state in which they are separated from each other. A reason why the loop roller pair 240 is moved before the resist roller pair 212 is that the paper rear edge is removed therefrom first and the next paper reaches the loop roller pair 240.

At time t12, the control unit 50 subjects the resist-roller swing motor 222 to backward drive (backward rotation), thereby moving the resist roller pair 212 to the home position in the state in which they are separated from each other.

At time t13, the control unit 50 turns off the loop-roller swing motor 250 to stop the swing operation of the loop roller pair 240. Moreover, as the swing operation is stopped, the control unit 50 turns on (backward drive) the loop pressure-contact/release motor 248, thereby bringing the loop roller pair 240 into a pressure-contact state.

At time t14, when the resist roller pair 212 is moved to the home position, the control unit 50 turns off the resist-roller swing motor 222 to stop the swing operation of the resist roller pair 212.

At time t15, based on the detection result of the resist sensor 340, the control unit 50 turns on the resist pressure-contact/release motor 282, thereby bringing the resist roller pair 212 into a pressure-contact state.

As described above, according to the present embodiment, since the abutment member 320 which can be moved forward/backward is provided in the conveyance path R, in the front edge detection of the paper P by the paper-front-edge detecting sensor 360, the paper P can be conveyed while the front edge portion of the paper P is pressed against the inner surface side of the guide plate 410 by the abutment member 320. As a result, the passage position of the paper P in the height direction in the conveyance path R can be caused to be constant (fixed). Therefore, detection accuracy of the paper-front-edge detecting sensor 360 can be improved. Particularly, when the paper P of thin paper or a largely-curled paper type is used, notable effects can be obtained.

Moreover, in the present embodiment, since the deviation correction is carried out after the paper P is separated from the guide plate 410, generation of sliding resistance, etc. between the paper P and the guide plate 410 in the swinging can be suppressed. As a result, reduction in the swing accuracy of the deviation correction can be prevented.

Moreover, according to the present embodiment, since the speed in the period in which the abutment member 320 is abutting the paper P is set to equivalent to or higher than the conveyance speed of the paper P, the abutment of the paper P to the guide plate 410 can be prevented from causing conveyance resistance. In other words, since the abutment member 320 does not have the conveyance resistance with respect to the paper P and also does not have conveyance force almost at all, the conveyance of the paper P is not affected. As a result, occurrence of clogging, jamming, buckling, etc. of the paper P can be also suppressed.

Furthermore, since the abutment mechanisms 300A, 300B are disposed in the opposite side of the image forming surface to which images are transferred to the paper, scratch flaws, etc. can be reliably prevented from being formed on the images when the abutment members 320, 320a, and 320b are pressed against the paper P. Moreover, since the abutment members 320, 320a, and 320b are formed of flexible members, even in the case of a both-side print mode, conveyance resistance is not caused, and, therefore, damages, etc. can be prevented from being formed on the images.

The technical range of the present invention is not limited to the above-described embodiments, but includes the above-described embodiments with various changes within the range not deviating from the gist of the present invention.

In the above-described embodiments, the bending correction of the paper P is carried out by the resist roller pair 212, but the present invention is not limited thereto. For example, the resist roller pair 212 is used as conveyance rollers, a side guide plate or a shutter member, which are publicly known techniques is provided in the upstream side of the resist roller pair 212 in the paper conveyance direction D1, and bending of the paper P may be corrected by these members.

Moreover, the above-described embodiments employ the rotatable abutment member as the abutment mechanism 300A or 300B. However, the present invention is not limited thereto. For example, an abutment mechanism having an abutment member configured to be movable forward/backward with respect to the conveyance path R by upward/downward movement can be employed. In this case, at the front edge portion of the abutment member, for example, a drive roller is provided, and the rotation speed of the drive roller is preferred to be subjected to rotary drive equivalent to or higher than the paper conveyance speed. As a result, the friction between the abutment member and the paper P can be reduced, and generation of resistance can be prevented. For example, if the rigidity of the paper P is low, the present abutment mechanism can be employed.

Moreover, in the above-described embodiments, the rotary operation of the abutment member 320 is configured to be carried out before the deviation correction. However, the present invention is not limited thereto. For example, if the pressing force of the abutment member 320 with respect to the paper P is small or if a condition such as a low rigidity of the paper P is satisfied, control can be carried out so that the rotation of the abutment member 320 is started during the deviation correction.

Moreover, if a problem similar to that of the present invention occurs, for example, if sensitivity is different depending on the passage position of the paper in the height direction in a conventionally-used paper-front-edge detecting sensor, the paper conveyance control by the above-described abutment mechanism 300A, etc. of the present invention can be applied.

Moreover, in the above-described embodiments, the loop roller pair 240 is taken as an example of an upstream-side roller pair. However, the present invention is not limited thereto. For example, the present invention can be also applied to a roller pair disposed in the upstream side (including ADU 60) of the loop roller pair 240 in the paper conveyance direction D1.

Moreover, in the above-described embodiments, the image forming apparatus 100 forms color images. However, the present invention is not limited to the image forming apparatus which forms color images, but may be an image forming apparatus which forms monochrome images.

Furthermore, the execution order of the processes such as steps (operations) in the apparatus shown in the present specification is not limited to the above-described order.

Although the present invention has been described and illustrated in detail, it is clearly understood that the same is by way of illustrated and example only and is not to be taken by way of limitation, the scope of the present invention being interpreted by terms of the appended claims.

What is claimed is:

1. An image forming apparatus comprising:
a roller pair configured to convey paper along a conveyance path;
a guide member provided in the conveyance path;
a detection unit provided in a downstream side of the roller pair in a first direction of a paper conveyance direction and configured to detect a front edge position of the paper;
an abutment mechanism provided in a downstream side of the roller pair in the first direction and in an opposite side of the detection unit with the conveyance path interposed therebetween, the abutment mechanism having an abutment member movable forward/backward with respect to the conveyance path; and
a control unit configured to carry out front-edge correction of aligning an image and a paper front edge based on a front edge position of the paper detected by the detection unit, wherein
in the front edge correction, the control unit controls operation of the abutment member so that a front edge portion of the paper passes through the detection unit in a state that the front edge portion of the paper is abutting the guide member.

2. The image forming apparatus according to claim 1, wherein
the abutment member is a flexible member.

3. The image forming apparatus according to claim 2, wherein
the abutment mechanism includes
a shaft unit to which the abutment member is attached and
a drive unit configured to subject the shaft unit to rotary drive.

4. The image forming apparatus according to claim 1, wherein
in the front-edge correction, the control unit moves the abutment member from an escape position at which the paper is separated from the guide member to an abutment position at which the paper abuts the guide member.

5. The image forming apparatus according to claim 4, wherein
after the front edge portion of the paper passes through the detection unit, the control unit moves the abutment member to the escape position.

6. The image forming apparatus according to claim 1, wherein
a speed of the abutment member when the abutment member abuts the paper is set to be equal to or higher than a paper conveyance speed.

7. The image forming apparatus according to claim 1, further comprising a movement mechanism configured to correct deviation of the paper with respect to an image by moving in a second direction orthogonal to the first direction in a state that the paper is sandwiched by the roller pair.

8. The image forming apparatus according to claim 7, wherein
the control unit carries out the deviation correction after the abutment member is caused to escape to the escape position.

9. The image forming apparatus according to claim 1, further comprising a transfer unit configured to form an image on the paper, wherein
the detection unit and the guide member are disposed in an image forming surface side in which the image is formed by the transfer unit.

10. The image forming apparatus according to claim 1, wherein
the roller pair is a resist roller pair configured to carry out bending correction of the paper.
